(19) United States
(12) Patent Application Publication
(10) Pub. No.: US 2013/0216345 A1
(43) Pub. Date: Aug. 22, 2013

(54) 3-Point Hitch Hydraulic Lifter

(71) Applicant: Brooks P. Townsend, Hattiesburg, MS (US)

(72) Inventor: Brooks P. Townsend, Hattiesburg, MS (US)

(73) Assignee: Brooks Pierce Townsend, Hattiesburg, MS (US)

(21) Appl. No.: 13/397,748

(22) Filed: Feb. 16, 2012

(51) Int. Cl. B66F 9/06

(52) U.S. Cl. 414/703

(57) ABSTRACT

Apparatus for lifting heavy objects by means of a hydraulically actuated, hinged “A” frame, supported from a tractor by means of the 3-point hitch connection. The “A” frame attaches directly to the 3-point hitch and supports a second hinged frame which is hydraulically actuated to provide lifting capability. This lifting apparatus can accommodate a multitude of lifting attachments i.e. a spear for moving large round bales of hay, pallet forks for sliding under a particular object, a bucket, grapple, etc. In operation, the operator will back the tractor to the object to be moved, secure the object by any of the means described above (spear, forks, bucket, grapple, etc.), lift the object for transport and/or lift to any height and configuration desired and discharge the load.

### REFERENCES CITED

U.S. Patent Documents

| | | |
|---|---|---|
| 3,934,726 | January 1976 | Martin |
| 4,120,405 | October 1978 | Jones et al. |
| 4,299,522 | November 1981 | Barton et al. |
| 4,674,786 | June 1987 | Lynch |
| 4,306,825 | December 1981 | Yilit |
| 5,150,999 | September 1992 | Dugan |
| 6,663,338 | December 2003 | Gregory, Jr. et al |
| 6,030,170 | Feb. 29, 2000 | Lewis |
| 5,556,245 | Sep. 17, 1996 | Moss |

### BACKGROUND OF THE INVENTION

1. Field of the Invention

The invention presented here is a device for lifting, moving, and/or stacking large heavy objects. More particularly, this invention relates to a device which can be attached to the 3-point lift of any existing tractor to convert such tractor into a machine which would handle the duties of a fork lift or front loader machine.

2. The Prior Art

At the present time, forklifts and front-end loaders are usually required to lift, move, and/or stack large heavy objects. However, the front-end loader and/or forklift each constitutes an extra piece of equipment over and above the tractor which may already be available. The present invention is an add-on or attachment to the tractor making the need to buy or rent a front-end loader or forklift unnecessary.

A preliminary search was conducted on the above invention and the following U.S. Patents were uncovered in the search:

| Inventor | U.S. Pat. No. | Issue date |
|---|---|---|
| Martin | 3,934,726 | Jan. 27, 1976 |
| Jones et al. | 4,120,405 | Oct. 17, 1978 |
| Barton et al. | 4,299,522 | Nov. 10, 1981 |
| Lynch | 4,674,786 | Jun. 23, 1987 |
| Yilit | 4,306,825 | Dec. 22, 1981 |
| Dugan | 5,150,999 | Sep. 29, 1992 |
| Gregory Jr. et al. | 6,663,338 | Dec. 16, 2003 |
| Lewis | 6,030,170 | Feb. 29, 2000 |
| Moss | 5,556,245 | Sep. 17, 1996 |

The Martin Patent discloses a bale carrier having a pair of tines 40 and 42 which are pivotally connected to a pipe 24. The tines will pierce a bale of hay adjacent the bottom and a hook 52 will engage the bale near the top to securely grasp the bale. This arrangement utilizes the tractor 3-point lift exclusively for the lifting mechanism.

The Jones et al Patent shows a spear-type device for impaling a bale of hay. The device can be attached to a front end loader or to a 3-point hitch. This device can be utilized as an added feature of the presently described mechanism.

The Barton et al Patent shows a bale lifting device comprising a pair of parallel tines pivotally mounted to the forward end of a tractor. This arrangement is limited to lifting for transport only.

The Lynch Patent shows a bale handling device having a larger spike 32 and a pair of auxiliary spikes 46, all mounted on a frame 10. The device is designed to be used with a conventional 3-point hitch and is similar to the Jones et al Patent described above.

The Yilit Patent shows a bale handling apparatus comprising a pair of parallel tines 33 and 34 pivotally mounted on a frame 20. The frame is adapted to be attached to a 3-point hitch on a tractor and is also limited to lifting for transport only.

The Dugan Patent shows several lifting devices, one of which attaches to the 3-point lift of a tractor and utilizes a walking beam arrangement which maintains the attached hay spear level.

The Gregory Jr. et al Patent shows a lifting device attached to the 3-point lift of a tractor with a cable arrangement specifically for use with a bucket.

The Lewis Patent shows a lifting device attached to a 3-point lift of a tractor that utilizes a cable arrangement and boom with a lift hook.

The Moss Patent shows a fork lift arrangement for lifting mounted to the 3-point lift of a tractor.

### SUMMARY OF THE INVENTION

The present invention involves a lifting device which is attached to a conventional 3-point hitch on a tractor and is used for the purpose of lifting, moving and/or stacking large heavy objects. It is unique in mechanical design, attachment, and lifting capability from other designs.

### BRIEF DESCRIPTION OF THE DRAWINGS

FIG. 1 is a side elevation of a tractor showing the present invention attached to the 3-point lift of a tractor;

FIG. 2 is a partial side elevation, on an enlarged scale, of the lifter shown in FIG. 1;

FIG. 3 is a profile view of the elements shown in FIG. 2; NOTE that the hydraulic cylinders (23) & (27) and the load attaching mechanism (30) have been omitted for clarity.

### DETAILED DESCRIPTION OF THE DRAWINGS

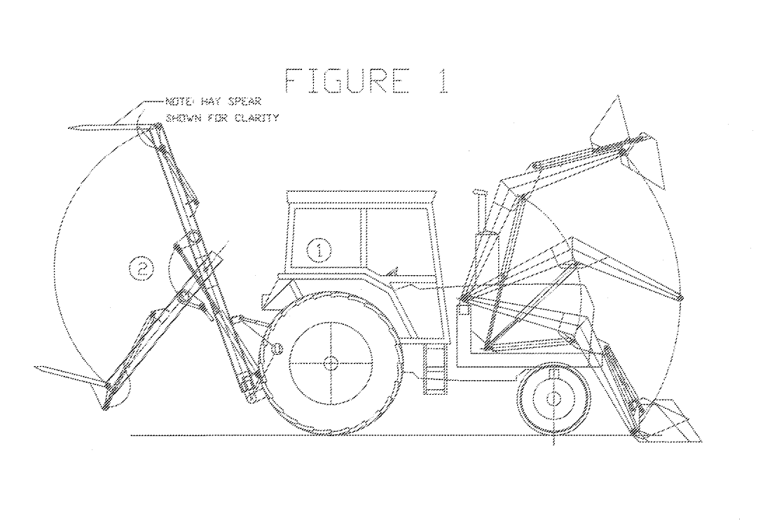

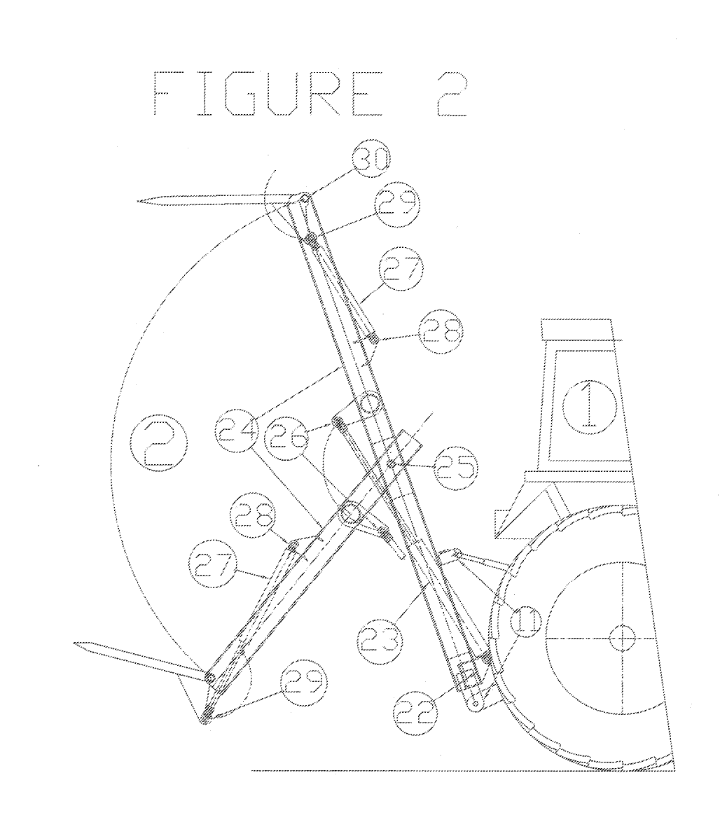

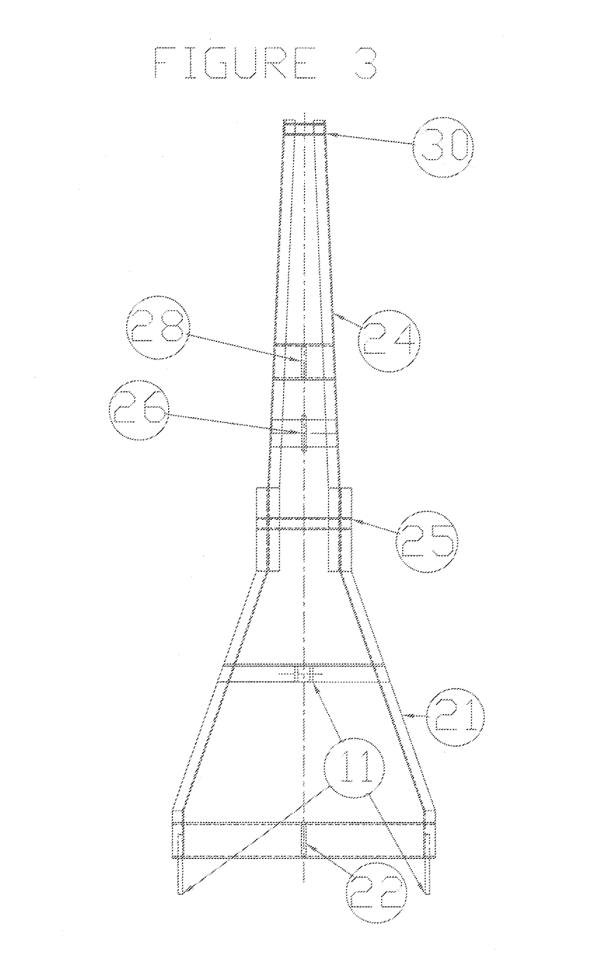

Referring to the drawings in detail, FIG. 1 shows a tractor (1) to which the lifter (2) of the present invention is attached. Referring also to FIGS. 2, and 3, the lifter (2) composed of an “A” frame of welded channels (21) with a hinge at the upper end, lower and middle attachments (11) for connection to the tractor 3-point lift, and a hydraulic cylinder (23) which is attached to the lower cross beam at (22) and to the upper frame (24) at location (26). The upper frame, which is also welded channel, (24) is connected to the lower frame (21) at hinge (25) and at the lower hydraulic cylinder connection (26). Upper frame (24), which has a hinge connection on both ends (25) and (30), includes a hydraulic cylinder (27) connected to the frame at (28) and to the lifting device (30) (in this case a hay spear is shown for simplicity) connected at (29). For the sake of simplicity, there are no hydraulic lines shown connected to either cylinder (23) or (27). Note also that in FIG. 3 both hydraulic cylinders (23) and (27) and the lift device (30) have been omitted for clarity.

### DETAILED DESCRIPTION OF THE INVENTION

In operation, the load is engaged by backing the tractor into the load until it is secured (in this illustration, a hay spear is utilized). Upon securing of the load, the load can then be hoisted from the ground by the tractors own 3-point lift (11), which will raise the load as well as the presently described lift apparatus. Or, the operator may choose to raise the load by energizing the lower hydraulic cylinder (23), which will cause the upper frame (24) to rotate about the hinge (25), thus raising the attached load. Either or both of these options are at the operators' disposal. If the operator chooses to raise the load for stacking or other reasons, the lower hydraulic cylinder (23) is further energized until the desired height is reached up to and including the maximum height as shown, whereupon the operator may position the load into any position desired by energizing the upper hydraulic cylinder (27) which causes the load to rotate about the hinge (30). The load is then disengaged by driving the tractor forward.

Whereas the present invention has been disclosed in terms of the specific structure described above, it should be understood that other and further modifications may be made within the spirit and scope of this invention.

What is claimed is:

1. A device for lifting, moving and stacking large heavy objects or material attached to a conventional tractor by the 3-point lift system. The device utilizes a large rigid “A” frame which is directly attached to the 3-point lift system on the tractor. The “A” frame supports a second hinged frame which is raised and lowered, via rotation, hydraulically. The second frame likewise supports a lifting attachment (hay spear, pallet forks, grapple, etc.) which is also rotated hydraulically. The device operates in a fashion similar to any existing front-end loader; the obvious difference is that it has the advantage of utilizing the tractors existing 3-point lift system thereby making it faster to attach/detach, without need of a special mounting frame. Conventional front-end loaders require a custom mounting frame for every model of every make of tractor. These custom frames are permanently mounted on each tractor. While some front loader manufacturers claim a quick attach system, they are far from quick and some or all of the loader remains permanently attached.
These factors contribute to a substantially more economical lifting system, both to build and market, and is therefore more affordable. The presented lift system is universally mounted, that is without a custom mount, and thereby frees the tractor from unnecessary load. The present device is unique in, mechanical design, attachment, and lifting capability from other designs.
